(19) United States
(12) Patent Application Publication
(10) Pub. No.: US 2005/0233662 A1
(43) Pub. Date: Oct. 20, 2005

(54) Self-adhesive textile surface covering

(76) Inventors: William C. Kimbrell, Spartanburg, SC (US); John L. Sanchez, Greenville, SC (US)

Correspondence Address: MILLIKEN & COMPANY, 920 MILLIKEN RD (M-495), PO BOX 1926, SPARTANBURG, SC, 29304, US

(21) Appl. No.: 10/825,820

(22) Filed: Apr. 16, 2004

(51) Int. Cl. B32B 27/36; B32B 27/04; B32B 27/12

(52) U.S. Cl. 442/149; 442/2; 442/33; 442/43; 442/49; 442/50; 442/58; 442/76; 442/150; 442/151; 442/286; 442/295; 442/299; 442/412

(57) ABSTRACT

An adhesive-textile composite is disclosed, comprising a textile, having a minimum tear strength, to the back of which is applied either a pressure sensitive adhesive or a thermoplastic hot-melt polymer. The face side of the textile comprises a hydrophobic surface, which is achieved by use of hydrophobic yarns and/or by application of a low surface energy treatment such as fluorocarbons, silicones, or waxes. The hydrophobic nature of the textile surface acts as an adhesive release agent, providing a number of benefits, including the feature that the adhesive-textile composite can be rolled up without the use of release paper. The face of the textile component of the composite may be printed, patterned, or otherwise treated to provide decorative and/or functional characteristics, as desired, depending on the intended use of the composite.

### TECHNICAL FIELD

The present disclosure relates to an adhesive-textile composite useful for covering a variety of surfaces. The adhesive-textile composite includes a textile component with a hydrophobic face and an adhesive back, which may be-a pressure sensitive adhesive or a thermoplastic hot-melt polymer. The adhesive-textile composite is contemplated for many uses and is particularly well-suited for use as a wall covering.

### SUMMARY

An adhesive-textile composite is disclosed, comprising a textile, having a minimum tear strength, to the back of which is applied either a pressure sensitive adhesive or a thermoplastic hot-melt polymer. The face side of the textile comprises a hydrophobic surface, which is achieved by use of hydrophobic yarns and/or by application of a low surface energy treatment such as fluorocarbons, silicones, or waxes. The hydrophobic nature of the textile surface acts as an adhesive release agent, providing a number of benefits, including the feature that the adhesive-textile composite can be rolled up without the use of release paper. The face of the textile component of the composite may be printed, patterned, or otherwise treated to provide decorative and/or functional characteristics, as desired, depending on the intended use of the composite.

### DESCRIPTION OF THE DRAWINGS

FIG. 1A is a schematic representation of the processing of a textile component through a treatment zone in which a low surface energy treatment is applied to the face side of the textile and an adhesive is applied to the back of the textile;

FIG. 1B is a schematic cross-sectional view of one embodiment of the present composite showing a textile layer, wherein a low surface energy treatment has been applied to one side and an adhesive has been applied to the opposite side;

FIG. 2A is a schematic representation of the processing of a textile component through a treatment zone in which a thermoplastic hot-melt polymer is applied to the back of the textile;

FIG. 2B is a schematic cross-sectional view of a second embodiment of the present composite showing a textile layer, in which a thermoplastic hot-melt polymer has been applied to one side;

FIG. 3A is a schematic representation of the processing of a textile component through a treatment zone in which a pressure sensitive adhesive is applied to the back of the textile;

FIG. 3B is a schematic cross-sectional view of a second embodiment of the present composite showing a textile layer, in which a pressure sensitive adhesive has been applied to one side;

FIG. 3C is a schematic cross-sectional view of a third embodiment of the present composite showing a textile layer, in which an adhesive has been applied to one side, and further showing a release sheet covering the adhesive;

FIG. 4A is a first schematic representation of the present composite when used as a wall covering;

FIG. 4B is a second schematic representation of the present composite when used as a wall covering;

FIG. 4C is a third schematic representation of the present composite when used as a wall covering.

### DETAILED DESCRIPTION

Adhesive-Textile Composite Description

The present disclosure relates to a self-adhesive textile composite, comprising a textile component to the back of which is applied either a pressure-sensitive adhesive or a thermoplastic hot-melt polymer. The face side of the textile comprises a hydrophobic surface, achieved by use of hydrophobic yarns and/or by application of a low surface energy treatment, such as fluorocarbons, silicones, or waxes. These components and various optional, additional components will be described in the following paragraphs.

The present adhesive-textile composite may be applied to a variety of surfaces that are substantially dry, dust-free, and non-friable. The composite can adhere to vertical surfaces (e.g., as applied to walls or cabinets), to horizontal surfaces (adhesive side down, as applied to, e.g., floors or tabletops), to horizontal surfaces (adhesive side up, as to accommodate application to ceilings), and to angular surfaces (adhesive side down, as for coverage applications involving a variety of surfaces, and adhesive side up, as for applications involving sloped ceilings, etc.). A fundamental consideration in use of the present adhesive-textile composite, discussed in more detail herein, is that the tear strength of the textile component exceeds the peel strength of the composite as applied to a surface.

The terms “lace” and “back” shall refer to respective opposing sides of the textile component and the self-adhesive textile composite. “Face” shall refer to the side of the textile (and composite) that is outwardly facing, or observable, during use. “Back” shall refer to the side of the textile composite that is in contact with a surface during use or, in the discussion of the textile component, the side that is covered by an adhesive layer.

Textile Components

The textile component is constructed from organic fibers, filaments, or yarns. The term “organic” is intended to encompass both natural materials and synthetic materials having a carbon-based molecular structure. Such organic fibers or yarns may be comprised of commonly available materials such as nylon, polyester, polypropylene, acrylic, olefins such as polyethylene and polypropylene, cellulosic materials (e.g., rayon or cotton), blends thereof, and other materials having an organic or natural construction. It should be understood that the discussion of any specific polymer herein is intended to include not only homopolymers, but also co-polymers thereof.

Synthetic fiber types are generally preferred over natural fibers, because of their resistance to microbial degradation and their tendency to resist swelling when wet. Among synthetic fibers, polyester is preferred over nylon, because of its resistance to permanent staining and because of its naturally hydrophobic nature. The selected yarn (or yarns, if different types are used) optionally may be dyed, as where accent yarns in the final product are desired or where yarns particularly suited to solution dyeing (e.g., polypropylene) are used. The yarns may be textured or untextured, depending on the desired appearance and use of the self-adhesive textile composite.

Possible constructions of the textile component include various types of weaving and knitting, as well as the use of non-woven constructions. Most nonwoven fabrics have a tendency not to unravel or fray when cut, which may be advantageous in some applications of this composite. For most applications, the textile component preferably has a smooth surface, although the surface may be subsequently contoured or patterned. Tufted or bonded substrates having a pile or napped surface may also be used, particularly when seeking to enhance the sound absorption characteristics of the composite, so long as the weight of the textile component does not exceed the peel strength of the composite from the surface to which it is applied.

The amount of stretch in the textile component affects the ease with which the adhesive-textile composite is handled and installed. Any appropriate degree of stretch in either the machine or cross-machine direction is generally acceptable. “Machine” and “cross-machine” refer, respectively, to the warp and fill of woven textiles, the wales and courses of knit fabrics, and the direction of the movement of a nonwoven textile as it is produced by the machine and the width of the machine. In certain applications—for instance, when conforming the composite to a curved surface—a higher degree of stretch would be desirable. When aligning multiple rows of a patterned or printed composite with one another, for example, when using as a wall covering, a lack of stretch is preferable. To minimize stretch, an additional coating (e.g., of polyurethane, acrylic polymers, and various copolymers) could be applied to the back of the textile component, before applying the adhesive. Alternatively, heat-setting a textile in its stretched state tends to minimize additional stretch.

For all constructions, the textile component of the composite preferably has a trap tear strength of at least 10 pounds in both the machine and cross-machine direction, as measured using ASTM Test Method D-5733-99, and, with respect to exhibiting a 10-pound minimum trap tear strength, is in fact isotropic (that is, is “minimally isotropic”). This minimum strength ensures that the textile component will not tear when being removed from the surface to which it is adhered.

Textile components, regardless of construction, possess certain fine-scale surface contours that result from the types of yarns and formation processes used to create the textile component. For instance, whereas film or paper has a relatively flat (smooth) surface profile, a textile product has a fine-scale contoured surface profile caused by the fibers within the yarns and the positioning of the yarns within the textile. The resulting fine-scale surface contours facilitate the penetration of a pressure sensitive adhesive or thermoplastic hot-melt polymer into the structure of the textile component, leading to a strong bond between the textile component and the adhesive component of the composite.

Such fine-scale surface contours, whose effects are more evident when the adhesive coating is at low add-on levels, provide another means for making adjustments to the tack and peel strength of the adhesive-textile composite. Composites including low-contour substrates will exhibit a greater accessible surface area for contact with the surface to which it is applied, as compared to a “bumpy” (that is, highly contoured) substrate. Accordingly, adhesive-textile composites that utilize flatter substrates will exhibit a larger amount of tack and peel strength when applied to a surface. The inherent contour of the textile component can be modified to optimize the desired amount of adhesive interaction.

Another benefit of these surface contours is found in the degree of bonding of the adhesive component to the face of the textile as the composite is rolled up. Without being bound by theory, it is believed that less of the face surface of the textile component (i.e., only the “peak” contoured areas) is in contact with the adhesive, thereby providing release points that aid in the unrolling of the composite.

Following formation of the textile component, the face and/or the back of the resulting textile component optionally may be subjected to various appropriate surface finishing operations, such as napping, sanding, brushing, or the like. The appropriately surface-finished textile component then may be optionally subjected to a heat setting step to stabilize the textile's width and shrinkage characteristics, as desired. In most instances, surface finishing may be used to improve the appearance, texture, or hand of the face of the textile component. However, it is contemplated that some surface finishing techniques may be employed on the back of the textile component, for example, to further improve the adhesion between the textile component and the adhesive component or other optional coating layers. Plasma treatment of either the yarns or the textile provides a chemical means for improving adhesion.

To further enhance the three-dimensional appearance of the textile composite, it may be desired to use a contoured textile component. Creating contours in the textile component can be achieved as part of the textile formation process (e.g., by jacquard weaving, dobby weaving, circular knitting, tricot knitting, or Raschel knitting), or can be achieved or enhanced during a subsequent step, in which a textile component that was formed with a planar surface (that is, with no fine-scale contouring) is treated to establish such a locally contoured surface. Individual processes include localized yarn shrinkage or melting by heated fluid streams (e.g., as disclosed in commonly assigned U.S. Pat. No. 5,148,583); yarn dislocation by high velocity fluid streams (e.g., as disclosed in commonly assigned U.S. Pat. No. 5,235,733); yarn deformation, as by, for example, embossing; and yarn melting or degradation, including chemical etching and degrading.

This collection of techniques is intended to be non-exclusive, and it is contemplated that two or more techniques may be used on the same textile component, and that other conventional processes may readily be used or adapted for use in modifying the appearance of the textile component as may occur to those skilled in the art.

The textile component may be printed or dyed, for example, to create aesthetically pleasing decorative designs on the textile component. The textile component may be colored by a variety of dyeing and/or printing techniques, such as high temperature jet dyeing with disperse dyes, thermosol dyeing, pad dyeing, transfer printing, screen printing, digital printing, ink jet printing, flexographic printing, or any other technique that is common in the art for comparable textile components. Printing may be done in-line with fabric formation or at a later time. In addition, the fibers or yarns comprising the textile component may be dyed by suitable methods before textile formation, such as, for instance, by package dyeing, solution dyeing, or beam dyeing, or they may be left undyed. In one embodiment, the textile component may be printed with solvent-based dyes rather than aqueous dyes, because solvent-based dyes may be more compatible with the adhesive release agents that will be described herein.

Adhesive Components

A number of factors must be weighed in choosing the appropriate adhesive and amount of adhesive. It is imperative that the adhesive form a strong and enduring bond with the back of the textile component (that is, the side to which the adhesive is applied). Equally important, as will be discussed further, there must be little to no bond between the adhesive and the face of the textile component. Another consideration is that the user should be able to easily break the bond between adhesive and adhesive, in cases where the adhesive side of the composite accidentally contacts itself. Yet another consideration is the cohesive strength of the adhesive.

The adhesive should possess long-term stability. First, the bond between adhesive-textile composite and a surface should not weaken over time when used in a variety of climatic conditions (for example, as may occur with temperature and humidity fluctuations); rather, the composite should remain securely attached to the surface without spontaneous peeling. Conversely, the bond between the adhesive and the surface should not strengthen (or “build”) over time. Regardless of the duration of attachment, i.e., from mere seconds to multiple years, the adhesive-textile composite should be removable from the surface without either substantially damaging the underlying surface or leaving substantial adhesive residue remaining on the surface.

Pressure sensitive adhesives of a solvent-based type, an emulsion type, or a hot-melt type are capable of meeting these requirements, as are thermoplastic hot-melt polymers. The characteristics and application methods of each will be described as follows.

Pressure Sensitive Adhesives

Of solvent-based, emulsion, and hot-melt types, emulsion-type pressure sensitive adhesives are preferred because of their ease of use in manufacturing; these types of aqueous-based adhesives are more easily used than solvent-based adhesives, which typically contain volatile organic compounds.

Hot-melt pressure sensitive adhesives may be used in certain applications. One example of a hot-melt pressure sensitive adhesive is a rubber co-polymer sold by National Starch & Chemical under the tradename EASYMELT® 34-591A.

When using pressure sensitive adhesives, many emulsion-type adhesives are readily available. The preferred emulsion-type pressure sensitive adhesive should exhibit the following properties: (a) sufficient lamination strength that it will remain attached to the textile component; (b) sufficient tack and peel strength that the adhesive-textile composite remains attached to the surface to which it is applied; and (c) a level of tack and peel strength, such that the adhesive-textile composite can be removed from a surface without substantially damaging the surface to which it was applied.

The preferred emulsion-type pressure sensitive adhesive is any one of a number of commercially available repositionable adhesives. “Repositionable” adhesives are those whose peel strength is less than both the cohesive strength of the adhesive and the strength of the surface to which the adhesive-textile composite is applied. Examples include an acrylic polymer adhesive sold under the tradename MULTI-LOK® 38-454A and a vinyl acetate adhesive sold under the tradename NACOR® 72-8761, both available from National Starch & Chemical of Bridgewater, N.J. Particularly well suited for this application are methacrylate-based pressure sensitive adhesives, an example of which is ROBOND® PS-8120 HV sold by Rohm & Haas of Philadelphia, Pa. Other classes of adhesives that may be used are documented in the reference book Handbook of Pressure Sensitive Adhesive Technology, edited by Don Satas and published by Van Nostrand Reinhold Co. (1982).

Emulsion type-pressure sensitive adhesives may be modified through the use of various additives to change characteristics such as tack, peel strength, cohesive strength, stiffness, and the like. Examples of such additives include, without limitation, wetting agents, such as wetting agents sold by Air Products under the tradename SURFYNOL® PSA-336 and by Union Carbide under the tradename TRITON® GR-5M; mechanical stabilizers, such as a mechanical stabilizer sold by Union Carbide under the tradename TRITON® X-200 and by Dow Chemical under the tradename DOWFAX® 2A1; thickening agents, such as a thickeners sold by Rohm and Haas under the tradenames ACRYSOL® ASE-60 and ACRYSOL® TT-615; cross-linking agents, such as a cross-linker sold by Ultra Additives under the tradename ZINPLEX® 15; tackifying agents, such as tackifiers sold by Arizona Chemical under the tradename AQUATAC® 6085, by Akzo Nobel under various tradenames, and by Eastman Chemical under various tradenames; detackifiers, or hardeners, such as a vinyl acetate homopolymer so!d by Rohm & Haas under the tradename RHOVACE® 177; defoaming agents, such as a defoaming agent sold by Cognis under the tradename FOAMSTER O® and by Crompton/Witco under the tradename BUBBLE BREAKER® 3056A; and a plasticizing agent, such as a plasticizer sold by Velsicol Chemical under the tradename BENZOFLEX® 50. Similar additives for solvent-based adhesives, as are known in the art, may be incorporated into solvent-based pressure sensitive adhesives.

Emulsion- and solvent-type pressure sensitive adhesives are typically applied using coating methods as may be known in the art, including, but not limited to, back-coating, knife coating, foam coating, kiss coating, or other suitable techniques. Optionally, a primer layer may be used to improve adhesion between the textile component and the adhesive component. Surface finishing on the back of the textile component has also been found to improve the bond of the adhesive component to the textile component.

Although common and, possibly preferable, to have the adhesive component cover substantially all the surface of the textile component, it is contemplated that a discontinuous covering of adhesive may also be used. Such a discontinuous application can be achieved by the use of a slot dyeing extrusion method, an engraved roll, screen printing, and other techniques as may be known by those of skilled in the art. The discontinuous application can form a pattern or can be random.

Thermoplastic Hot-Melt Polymers

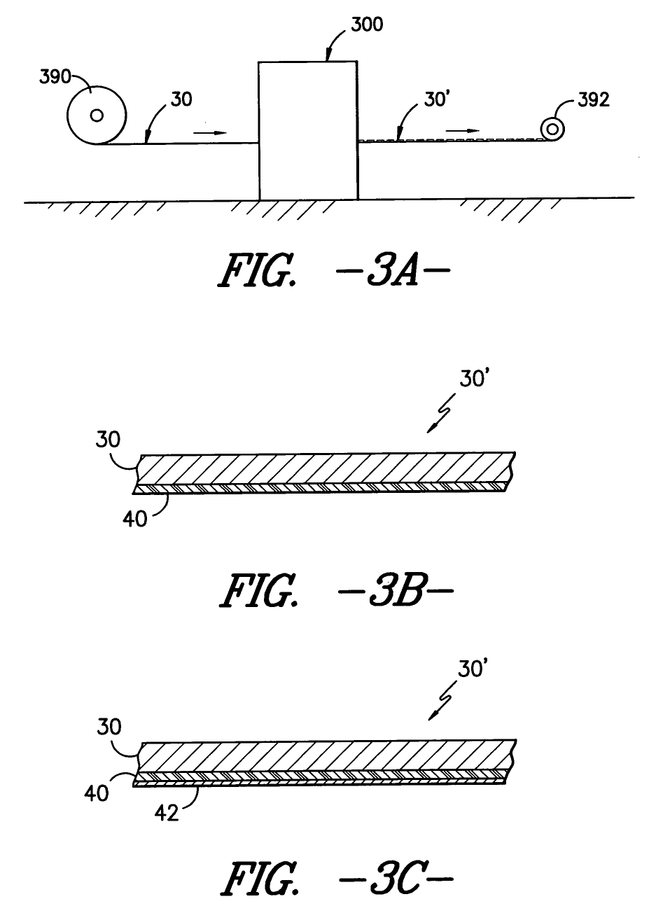

Thermoplastic hot-melt polymers, including olefins and acrylates (such as polymethylmethacrylate), are also suitable for use as the adhesive component of the present composite. Typically, these polymers are extruded directly onto the surface of the textile component or are extruded as films that are subsequently laminated onto the textile (as shown in FIG. 2A). Various types of desired additives, as will be described, may be incorporated directly into the polymer mix before extrusion. Unlike the pressure sensitive adhesives described above, thermoplastic hot-melt polymers exhibit little to no tack at room temperature as part of an adhesive-textile composite. As a result, no adhesive release agents or release sheets are required when using thermoplastic hot-melt polymers as part of the adhesive-textile composite.

Thermoplastic hot-melt polymers require the application of heat and/or pressure to fix the adhesive-textile composite to a desired surface. This process can be accomplished by the use of any standard household iron, heat gun, or the like. Once a thermoplastic hot-melt polymer-containing composite is applied to a desired surface, it exhibits similar peel strength to composites created using pressure sensitive adhesives. Removal of thermoplastic hot-melt polymer-containing composites is much different from those containing pressure sensitive adhesives. In the case of thermoplastic hot-melt polymers, removal may cause significant surface damage, or be impossible, unless the polymer is reheated.

Low Surface Energy/Adhesive Release Treatments

In a preferred embodiment, a low surface energy treatment is applied to at least the face surface of the textile component. The low surface energy treatment prevents the adhesive component from sticking to the face of the textile component when the composite is rolled up (e.g., in packaging). It also provides benefit in preventing the adhesive component from bleeding or seeping through to the face of the textile component (also known as “strike-through”). This treatment provides a further benefit in that it provides water repellency to the adhesive-textile composite, and, depending on the composition, oil repellency, both of which are important features in resisting stains during use. For these reasons, the compositions described can be categorized as “multi-functional adhesive release agents.”

Particularly in situations where the adhesive-textile composite will be rolled up for long periods, possibly experiencing a wide fluctuation in temperatures and humidity, it is preferred to include such a treatment to prevent the adhesive (back) of the composite from sticking to the face of the composite.

To obtain a low surface energy in the textile component, the textile component is treated with a hydrophobic agent. Hydrophobic agents include waxes, silicones, certain hydrophobic resins, fluoropolymers, and the like, and combinations thereof. Fluoropolymers are the preferred hydrophobic agents for this application. Potentially preferred compounds, which are intended only as examples and not to be limiting, include REPEARL® F8025 fluoropolymer and REPEARL® F-89 fluoropolymer, both available from Mitsubishi International Corporation of New York, N.Y., and ZONYL® 7713 fluoropolymer, available from E. I. DuPont deNemours of Wilmington, Del.

Aqueous emulsions of silicon-based compounds, including, for example, emulsions in which the silicone is cross-linked, are also useful as the adhesive release agent. Numerous silicon-based compounds may be employed over a wide range of molecular weights such as those containing polysiloxanes including, for example, polydimethyl siloxane and dimethyl hydrogen polysiloxane. Upon application of a top coating employing a silicone emulsion, it is preferred that the coating be heated to a temperature of at least 290° F. to properly cure the silicone material. Silicon-based compounds are characterized in that they provide good water repellency, but are notably not particularly good at repelling oil-containing stains.

Natural or synthetic waxes or mixtures thereof may also be used as adhesive release treatment. Although they are least capable of lowering the surface energy of the textile, they are water-resistant. Suitable naturally occurring waxes include mineral waxes such as crystalline or amorphous paraffin, vegetable waxes, and animal waxes such as beeswax. Suitable synthetic waxes include fatty alcohols and acids, fatty acid esters, and glycerides.

Particularly suitable chemical compositions for this purpose are the subject of U.S. patent application Ser. No. 10/340,300, filed Jan. 10, 2003, to Kimbrell, Jr. et al. and commonly assigned to Milliken & Company, the disclosure of which is hereby incorporated in its entirety by reference.

Alternative to Adhesive Release Treatment

The use of a low surface energy treatment may not be required in all cases. It has been found that when applying an appropriate pressure sensitive adhesive to certain types of textile components, a low surface energy treatment may be unnecessary. The ability of the textile component to self-release in the:absence of a release agent is affected by the adhesive properties (that is, using low-tack, low-strength adhesives make self-release more likely to occur regardless of the type of textile component used). However, relatively smooth polyester fabrics exhibit good release properties, even without a low surface energy treatment, as do other fabrics having a hydrophobic character.

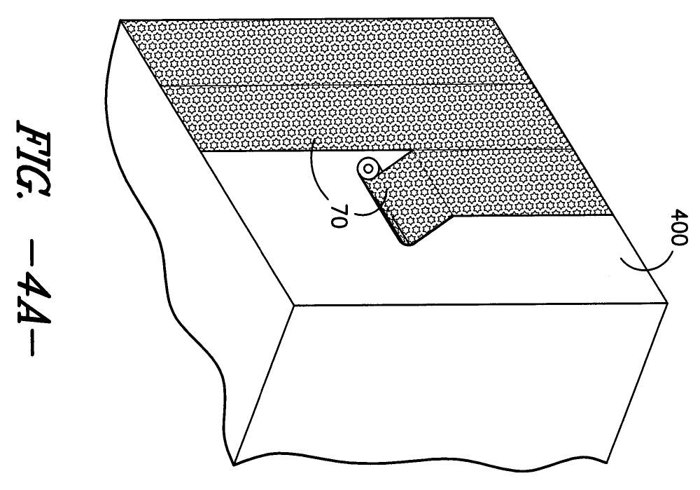

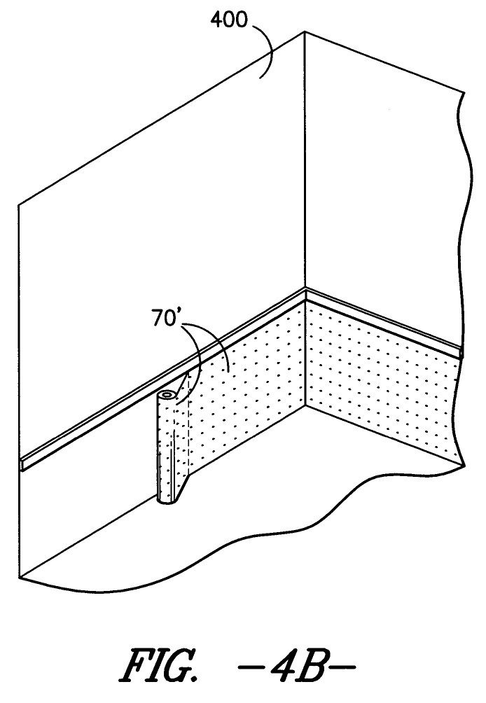

It has also been found that, when using thinner adhesives, incorporating a thickening agent into the pressure sensitive adhesive emulsion can sufficiently increase the viscosity of the adhesive to prevent strike-through, which would normally occur in the absence of an adhesive release agent. This feature allows the textile component to be rolled up without sticking to itself. This alternative works particularly well when using woven, knitted, or nonwoven substrates. Examples of thickeners suitable for this purpose include those sold by Rohm & Haas under the tradenames ACRYSOL® ASE-60 and ACRYSOL® TT-615. This embodiment is illustrated schematically in FIG. 3B.

Adhesive Release Sheets

As another alternative to the adhesive release treatments described above, it may be desirable for some applications to use release sheets that are removably attached to the adhesive component (as shown in FIG. 3C). As known in the art, “release sheets” are typically used to protect the adhesive component from contamination during subsequent processing (e.g., slitting, printing, and packaging). The user manually removes the release sheets before adhering the composite to the selected surface.

Release sheets, and methods for their preparation, are well known. Typically, the release sheet comprises a support sheet, such as craft paper, which is coated or impregnated on one surface. (the “release surface”) with a suitable release material, such as a silicone, which possesses properties of good release with respect to the adhesive component so that the consumer can readily remove the release sheet at a later date.

Stain Release Agents

To impart stain release properties to the textile component, it may be desirable to use a hydrophilic stain release agent, either alone or, preferably, in combination with the adhesive release agent described above. Hydrophilic stain release agents include ethoxylated polyesters, sulfonated polyesters, ethoxylated nylons, carboxylated acrylics, cellulose esters or ethers, hydrolyzed polymaleic anhydride polymers, polyvinylalcohol polymers, polyacrylamide polymers, hydrophilic fluorinated stain release polymers, ethoxylated silicone polymers, polyoxyethylene, polymers, polyoxyethylene-polyoxypropylene copolymers, and the like, and combinations thereof. Hydrophilic fluorinated stain release agents may be preferred. Potentially preferred compounds, which are intended only as examples and not to be limiting, include a fluoropolymer sold by Daikin Corporation under the tradename UNIDYNE® TG-992; a fluoropolymer sold by Mitsubishi Corporation under the tradename REPEARL® SR1100; and a fluoropolymer sold by E. I. DuPont deNemours under the tradename ZONYL® 7910.

Other Additives

Various other additives may be incorporated into the adhesive-textile composite to impart different properties to the composite. The following list is intended to be exemplary, rather than exhaustive. Other additives as are known to those of skill in the art may, of course, also be incorporated into the adhesive-textile composite.

By way of example, it may be desirable to treat the textile component with finishes containing chemicals such as antimicrobial agents, antibacterial agents, antifungal agents, mildew inhibitors, flame retardants, ultraviolet stabilizers, antioxidants, coloring agents, lubricants, antistatic agents, radio-frequency shielding additives, fragrances, odor absorbers or neutralizers, and the like, or combinations thereof. Chemical application may be accomplished by immersion coating, padding, spraying, foam coating, or by any other technique whereby a controlled amount of a liquid suspension may be applied to a textile component. Many such chemical compositions can be incorporated simultaneously with the low surface energy/adhesive release agent, or such compositions may be applied before treatment with the adhesive release agent and/or stain release agent. It is also possible, using appropriate techniques, to apply many such chemical compositions after treatment with the release agent and/or stain release agent. It is further possible to incorporate many of the chemical additives listed above into the adhesive component before application to the textile component.

Some of the additives listed above, such as antimicrobial agents, odor absorbers and neutralizers, and ultraviolet stabilizers, tend to permeate the fibers of the textile component during application. In some instances, additives may form a coating on the surface of the textile component. Flame retardant chemicals may be applied either as a coating on the surface of the textile component, as an additive within the adhesive component, as an additive extruded in the fiber, or as a discrete layer between the adhesive component and the textile component.

Processing Methods

Application of the hydrophobic adhesive release agent and, optionally, the hydrophilic stain release agent to the textile component is accomplished by a variety of application methods, including immersion coating, padding, spraying, foam coating, exhaustion techniques, or by any other technique whereby a controlled amount of a liquid suspension may be applied to a textile component. Employing one or more of these application techniques may allow the agent(s) to be uniformly applied to the textile component.

The adhesive release agent and, optionally, the stain release agent may be applied simultaneously or sequentially to the textile component. For example, the agents may be combined in one solution, perhaps with a cross-linking agent, and then simultaneously applied to the textile component by padding. After application of the chemical agent(s) to the textile component, the treated textile component is generally exposed to a drying step to evaporate excess liquid, leaving the solid active components on the surface of the treated textile component. In yet another embodiment, the stain release agent is applied to the textile component, and then the adhesive release agent is applied to either a wet or dry textile component, creating a layered, sequential chemical treatment on the surface of the textile component.

Drying can be accomplished by any technique typically used in manufacturing operations, such as dry heat from a tenter frame, microwave energy, infrared heating, steam, superheated steam, autoclaving, or the like, or any combination thereof. It may be desirable to expose the treated substrate to an additional heating step to further enhance the performance or durability of the chemical agent(s). By way of example, additional heating may (a) enable discrete particles of the active components of the chemical agents to melt-flow together, resulting in uniform, cohesive film layers; (b) induce preferred alignment of certain segments of the chemical agents; or; (c) combinations thereof.

Slitting the textile-adhesive composite to prevent fraying is accomplished via techniques that heat-seal the edges, namely hot knife cutting, ultrasonic cutting, and laser cutting. To minimize fraying of the cut composite, as may be necessary in various applications, use of a rotary cutting tool is recommended. Other techniques that minimize fraying include the use of nonwoven textile components, coating the textile component with a polymer composition or laminate before application of the adhesive, impregnating the textile component with a polymer composition (such as size), and fully or partially impregnating the textile component with the adhesive component (as has been described).

### DETAILED DESCRIPTION OF THE DRAWINGS

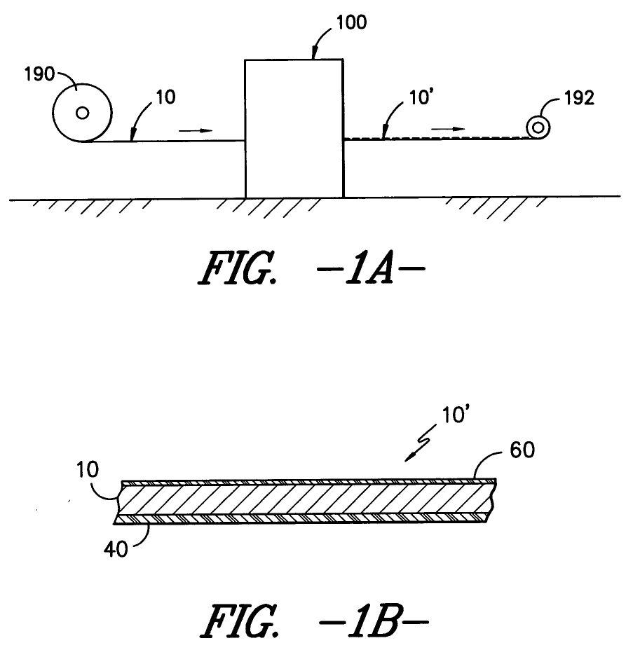

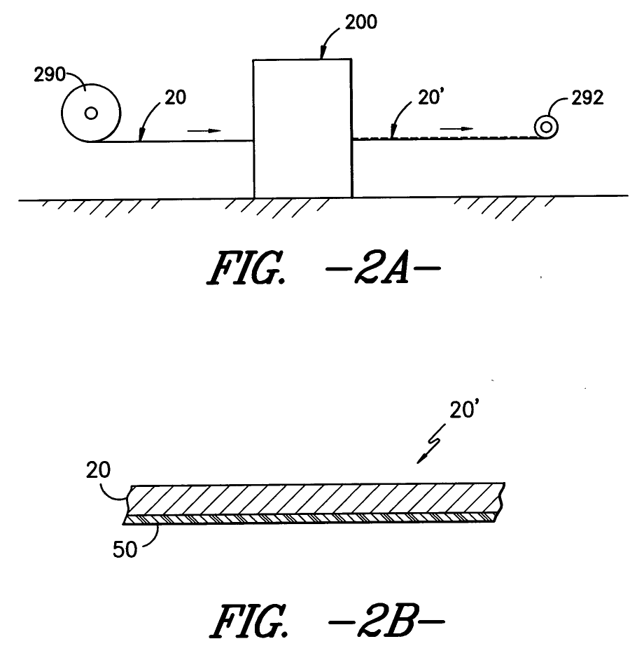

Turning now to the Figures, FIG. 1A is a schematic representation of the processing of a textile component 10 from carrier roll 190 through a treatment zone 100 onto take-up roll 192, resulting in the creation of adhesive-textile composite 10′ (shown in FIG. 1B). In this preferred method, treatment zone 100 includes a two-sided coating apparatus, which allows the simultaneous application of release treatment 60 to the face of textile component 10 and of pressure sensitive adhesive 40 to the back of textile component 10. Such coating can be accomplished by foam-coating both release treatment 60 and pressure sensitive adhesive 40 onto textile component 10. Alternatively, release treatment 60 and pressure sensitive adhesive 40 can be applied sequentially, using other application techniques as have been described.

As shown in FIG. 1B, adhesive-textile composite 10′ includes both adhesive release treatment 60 and adhesive 40, both of which are at least partially incorporated into textile component 10. Penetration of adhesive 40 into textile component 10 is important in creating a strong physical bond between components 10, 40, thereby preventing delamination (that is, separation) at a later time. It should be noted that the degree of penetration of both adhesive release treatment 60 and adhesive 40 may be controlled based on the application technique. Furthermore, the depiction of the degree of penetration shown in FIG. 1B is intended to be representative, rather than limiting. By way of example, when applying adhesive release treatment 60 by padding, adhesive release treatment 60 is typically absorbed throughout textile component 10, rather than being partially incorporated as would be expected with a foam application. Foaming adhesive release treatment 60 onto textile component 10 may be preferable, because the foamed adhesive release treatment 60 will not penetrate fully throughout textile component 10, thereby enabling the deeper penetration of adhesive 40 into textile component 10.

FIG. 2A shows a similar processing of textile component 20 from carrier roll 290 through a treatment zone 200 onto take-up roll 292, resulting in the creation of adhesive-textile composite 20′ (shown in FIG. 2B). In this embodiment, treatment zone 200 includes a coating apparatus that extrudes a thermoplastic hot-melt polymer 50 onto the back of textile component 20. Extrusion temperature is dependent upon the polymer used, but for olefins and acrylates, the temperature is typically in the range of 500° F. to 520° F., but may be as high as 590° F.

As shown in FIG. 2B, adhesive-textile composite 20′ includes a thermoplastic hot-melt polymer 50, which is partially incorporated into textile component 20 to create a strong bond between components 20, 50. These kinds of thermoplastic hot-melt polymers typically tend to soften at temperatures between 180° F. and 400° F.

FIG. 3A shows the processing of textile component 30 from carrier roll 390 through treatment zone 300 and onto take-up roll 392, which results in the creation of adhesive-textile composite 30′. In this embodiment, treatment zone 300 includes a coating apparatus that coats the back of textile component 30 with a pressure-sensitive adhesive 40, although textile component 30 is not treated-with a release treatment as shown in FIG. 1B. Preferably, pressure sensitive adhesive 40 is of the emulsion-type and further may contain a thickening agent that prevents pressure sensitive adhesive 40 from seeping through textile component 30.

FIG. 3B represents a cross-sectional view of adhesive-textile composite 30′, in which pressure sensitive adhesive 40′ is partially incorporated into textile component,30. FIG. 3C represents an alternate embodiment in which a release sheet 42 is positioned over pressure sensitive adhesive 40′. Although not functionally necessary to prevent adhesive 40′ from sticking to the face of textile component 30 when rolled up, release sheet 42 may be desirable for some applications.

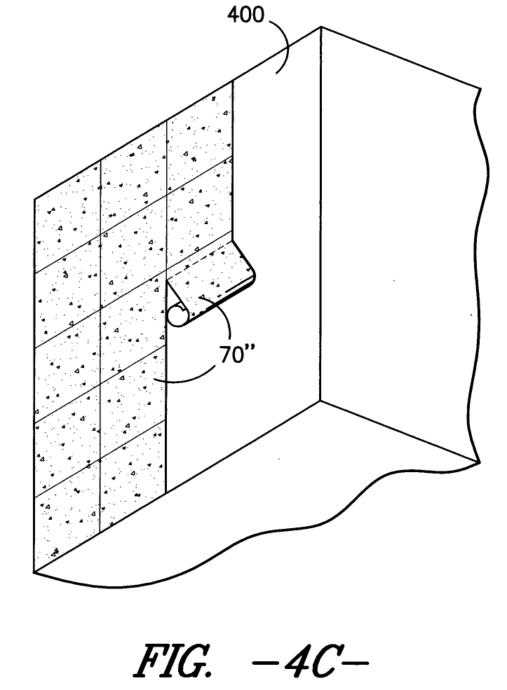

FIGS. 4A through 4C will be discussed in detail, as relates to one contemplated use described below.

Contemplated Use

The following discussion describes one contemplated use of the adhesive-textile composites described herein. In no way should this discussion be interpreted as limiting the many other possible uses of the present composite or the other surface orientations to which the composite is capable of adhering (e.g, horizontal and angular).

It has been found that the adhesive-textile composite (in its various embodiments as described herein) is especially well suited for use as a wall covering. The discussion below will be centered around the preferred composite embodiment, in which the textile component is coated on its face with a low surface energy treatment and on its back with a pressure sensitive adhesive.

For purposes of illustration, and not to be considered limiting, the present adhesive-textile composite can be produced for use as a wall covering using the following preferred process steps. Optionally, the textile component is printed and/or patterned and/or dyed, before further treatment. The textile component is subjected to treatment with the low surface energy treatment described above, which may preferably include stain release agents as well. Simultaneously or subsequently, the adhesive component is applied to the textile component on the back (that is, opposite the low surface energy treatment). If the textile component was not previously dyed or printed, printing and dyeing can occur at this point. Finally, the adhesive-textile composite is slit to the desired dimensions and packaged.

When thinking of traditional wall coverings, most people think either of paint or wallpaper. Wallpaper, which is usually paper or vinyl, is sold in standard width rolls (typically, 18 to 24 inches) or as borders of various widths (typically, all less than 18 inches). The present adhesive-textile composite provides an attractive alternative to wallpaper and wallpaper borders by overcoming a multitude of problems faced by those installing, using, and removing wallpaper.

First, wallpaper installation has long been viewed as messy, time-consuming, and difficult. Conventional wallpaper is adhered to the wall, using either adhesive backings that are activated by wetting the wallpaper (in the case of prepasted wallpapers) or wallpaper paste that is spread on the back of the wallpaper or on the wall itself (in the case of unpasted wallpapers). After wetting or applying adhesive, the wallpaper is “booked” or folded in a specialized way to ensure that the adhesive does not come into contact with the face of the wallpaper. These installation methods are tedious for all but the most sophisticated installers, typically mandating the use of water trays, brushes, smoothing rollers, drop cloths, razor blades, and a host of other tools, the purchase of which adds additional cost for the consumer.

Further, most wallpaper hanging failures are caused by poor surface preparation before hanging. Surface preparation includes, at a minimum, washing the walls to remove any dirt, grease, or grime that may have accumulated over time. If the walls are unfinished, however, as in the case of new construction, finishing the walls requires spackling, sanding, and, possibly, priming the walls with a base coat of paint or primer.

The present adhesive-textile composite overcomes these problems. Because a pressure sensitive adhesive is an integral part of the composite, the need for messy or wet adhesives is eliminated. Another advantage of the adhesive-textile composite, when used in this application, is its ability to be rolled up on itself, eliminating the need for “booking” or other specialized handling. Hanging the present composite requires only a level (to ensure that the panels are plumb) and a rotary cutter (for cuts at the ceiling and/or floor). The pressure sensitive adhesive allows the composite to be-repositioned multiple times, if necessary, on the wall, as might be desirable when aligning patterns of adjacent composite panels.

The use of the present adhesive-textile composite minimizes the time required for wall preparation, as the composite is capable of adhering to any dry, dust-free, solid surface. A surprising advantage of the adhesive-textile composite is its ability to mask wall defects and imperfections. The present adhesive-textile composite is capable of hiding imperfections ranging from screws and nail holes to unfinished drywall seams to holes or contusions in wallboard. This ability to hide defects translates into a time savings for installers whose time spent preparing the wall surface, when using this product, is minimized.

Another significant problem for many wallpaper owners is that the bond between the wallpaper and the wall is a permanent one. As anyone who has tried to remove wallpaper can attest, the removal process rivals, and perhaps surpasses, the installation process for being time-consuming, difficult, and tedious. Often, traditional wallpapers have multiple-layered structures that tend to separate during removal, requiring the person removing the wallpaper to uncover the wall layer-by-layer. Also probable is that the wallpaper itself will not come off the wall in uniform, whole sheets, but rather in irregular, shredded pieces. Like installation, removal has its own set of specialized tools: chemical sprays or gels, paper scoring tools, steamers, scrapers, and the like.

The present adhesive-textile composite overcomes these shortcomings as well. Because the composite is secured to the wall with a pressure sensitive adhesive, it is easily removed, with virtually no tools, from the wall at the discretion of the owner without leaving substantial adhesive residue on the wall and without substantially damaging the wall to which it was attached. The tear strength of the textile component is such that the composite is removable in the form in which it was hung, particularly advantageous if the owner wants to reinstall the composite in another room or at a subsequent date. This feature is the result of the engineered relationship between the composite′ s tear strength and its (lower) peel strength. Pressure sensitive adhesives, as have been described, tend to be long-term stable in use, meaning that the bond strength between the adhesive and the wall does not weaken over time nor strengthen over time.

The removability of the adhesive-textile composite provides an opportunity for decorating to those who might not otherwise be in a position to hang wallpaper. Specifically, the adhesive-textile composite can be used in apartments and dormitory rooms, where occupants are instructed not to permanently modify the walls. It is also contemplated that the composite is suitable for use in decorating a child′ s room, where parents desire that the room décor be modifiable to fit the child′ s changing tastes.

In commercial settings, such as hotels and offices, the removability of the adhesive-textile composite provides a number of benefits. Foremost, the composite panels are easily removed, allowing the owner the opportunity to remodel or make repairs without significant down-time. Additionally, should one composite panel be damaged, it is easily and quickly removed and replaced without the need for specialized tools. It is also contemplated that the adhesive-textile composite may include additives, such as flame retardants, mildew inhibitors, and the like, that will enhance the performance of the composite for its intended use.

Conventional wallpapers have other deficiencies that are overcome by the present composite. A conventional wallpaper may become damaged if sharply contacted, for instance, by the corner of a desk. The present composite possesses sufficient tear and burst strength that it is unlikely to be damaged when struck. Rather, the present composite can be repositioned over the underlying wall damage, thereby masking the damage.

Ability to maintain a clean and new-looking appearance is also an issue faced by users of conventional wallpaper. With textured wallpapers, as might be created by embossing, the issue is even more difficult to overcome. The present composite, in its preferred embodiment, includes a stain resistant low surface energy treatment. In a more preferred embodiment, it further includes a stain release and a stain repellent treatment. This combination of chemistry allows the composite to resist most kinds of stains, while allowing the user to remove those stains that are absorbed into the composite.

Turning back to the Figures, FIG. 4A shows a representation of one method of covering a wall 400 with rolls of adhesive-textile composite 70 that are adhered to wall 400 in adjacent and matching fashion. In practice, the consumer places one end of composite 70 at the upper edge of wall 400 and lightly adheres composite 70 to wall 400. The consumer then unrolls composite 70 from itself and adheres composite 70 to wall 400. Should one strip of composite 70 become misaligned, the consumer can easily remove composite 70 from wall 400 for repositioning.

FIG. 4B shows an alternate method for covering wall 400 with a roll of adhesive-textile composite 70′, which is positioned below a chair rail. In this embodiment, composite 70′ is used horizontally. Typically, large areas of a wall are covered by vertically positioned strips of wallpaper, rather than by the horizontal approach shown in FIG. 4B.

FIG. 4C shows a third representation of a method for covering wall 400, this time using multiple panels of adhesive-textile composite 70″. It should be noted that, although rectangular panels are shown, panels of other sizes and shapes would work equally well. Additionally, it may be desirable to use panels having a curved, or otherwise, irregular, edge (such as a wave pattern) to disguise or minimize the appearance of seams.

For any of the applications shown in FIGS. 4A-4C, it will be necessary to trim composite 70, 70′, or 70″, in order to fit the dimensions of wall 400. Trimming is also necessary for installation around architectural features, such as window and door casings, as well as at the ceiling and floor. As has been mentioned previously, a rotary cutting tool works well for this purpose and minimizes the potential for fraying.

The present composite will further be illustrated by the examples that follow. It should be understood that these examples are representative only and are not intended to be either exclusive or limiting.

### EXAMPLES

The following Examples discuss a variety of tests that were performed in evaluating the present adhesive-textile composite. The test methods and procedures, which were used in these tests, are described below.

Adhesive add-on is a measure of the amount of adhesive applied to the surface of the textile component. Clearly, higher numbers indicate the presence of more adhesive on the textile component.

Rolling ball tack is a measure of the number of inches a rolling ball will travel across the adhesive surface, when the ball is rolled down an inclined trough equipped with a release level at the top through which the ball gains downhill momentum. The test was conducted according to ASTM Test Method D-3121-94 (reapproved 1999). Lower distances indicate a tackier (that is, more sticky) surface.

The 90-degree peel strength test measures the amount of force (in pounds force/inch) necessary to peel the adhesive-coated textile from a surface. The test was conducted according to ASTM Test Method D-903-98. In this test, the adhesive-textile composites were adhered, unless otherwise noted, to primed sheetrock using a five-pound roller. The primer used was an interior PVA primer manufactured by Glidden. The adhesive-textile composite was then removed from the sheetrock, with a measurement being made of the force necessary for removal.

The delamination strength test measures the amount of force (in pounds force/inch) necessary to separate the textile component from the adhesive component. In this test, the adhesive component of the composite was glued to sheetrock using an epoxy adhesive. The textile component was then removed from the adhesive component, with a measurement being made of the force necessary for removal.

### Example 1

### Evaluation of Tear Strength and Burst Strength

Tear strength of different textile components was evaluated, using ASTM Test Method D-5733-99. Tear strength is the force required either to start or to continue a tear in a textile.

Burst strength is a test that measures the bursting strength of textile. The procedure was tested according to ASTM Test Method D-3787-89.

The textile components and competitive products tested are described below, and the corresponding results are shown in Data Table 1.

| | |
|---|---|
| Component 1A: | 2 × 2 basket weave; 100% polyester; warp having 3/150/34 |
| | polyester yarns and 64 ends/inch; fill having 3/150/34 polyester |
| | yarns and 44 picks/inch |
| Component 1B: | plain woven 100% polyester textile; warp having 3/150/50 |
| | polyester yarns and 39 ends/inch; fill having 3/150/50 polyester |
| | yarns and 41 picks/inch; finished weight of 6.34 ounces/yd² |
| Component 1C: | 6H crepe weave; 100% polyester; warp having 2/150/34 polyester |
| | yarns and 67 ends/inch; fill having 2/150/34 polyester yarns and |
| | 46 picks/inch; finished weight of 6.38 ounces/yd² |
| Component 1D: | 6H crepe weave; 100% polyester; warp having 1/150/36 polyester |
| | yarns and 66 ends/inch; fill having 1/150/36 polyester yarns and |
| | 54 picks/inch |
| Component 1E: | Fancy weave; 100% polyester; warp having 1/300/136 polyester |
| | yarns and 64 ends/inch; fill having 2/150/68 polyester yarns and |
| | 68 picks/inch; finished weight of 6.21 ounces/yd² |
| Component 1F: | Plain weave taffeta; 100% polyester; warp having 1/150/36 |
| | polyester yarns; fill having 1/150/36 polyester yarns |
| Component 1G: | Hydroentangled spunlace nonwoven; 100% polyester; randomly |
| | carded polyester |
| Component 1H: | Mock leno weave; 100% polyester; warp having 1/070/34 |
| | polyester yarns and 103 ends/inch; fill having 1/070/36 polyester |
| | yarns and 86 picks/inch; finished weight of 2.31 ounces/yd² |
| Component 1I: | Double-knit construction containing 2/150/68 Danbury-textured |
| | 100% polyester yarns, 1/150/72 100% polyester yarns, and |
| | 1/150/36 100% polyester yarns; 8.7 ounces/yard² |
| Component 1J: | Single needlebar knit construction; 1/150/34 yarns of 100% |
| | polyester; 7.5 ounces/yard² |
| Competitive Product A: | Duct tape, sold under the Duck ® brand by Henkel |
| | Consumer Additives |
| Competitive Product B: | Masking tape, sold under the name “Anchor II Advanced |
| | Adhesives” by Anchor Continental |
| Competitive Product C: | A self-stick wallpaper border, sold under the name “SofTac |
| | Adhesive Border” by D. W. Wallcovering |
| Competitive Product D: | A self-stick wallpaper border, sold under the name |
| | “Stick'nPlay Self-Stick Activity Border” by Imperial Home |
| | Décor Group. |

DATA TABLE 1

| | | |
|---|---|---|
| Machine | Cross-Machine | |
| Direction Tear | Direction Tear | Burst Strength |
| (lbf) | (lbf) | (lbf) |

Textile Components

| | | | |
|---|---|---|---|
| Component 1A | 136.3 | 85.6 | 417.2 |
| Component 1B | 57.6 | 50.3 | 338.3 |
| Component 1C | 57.6 | 42.3 | 361.2 |
| Component 1D | 35.2 | 25.8 | 201.8 |
| Component 1E | 25.7 | 51.1 | 252.2 |
| Component 1F | 20.3 | 15.1 | 167.9 |
| Component 1G | 16.1 | 11.4 | 78.3 |
| Component 1H | 11.0 | 13.8 | 139.9 |
| Component 1I | 39.5 | 44.4 | not evaluated |
| Component 1J | 48.1 | 31.9 | not evaluated |

Competitive Products

| | | | |
|---|---|---|---|
| Duct Tape | 6.1 | not evaluated | not evaluated |
| Masking Tape | 0.9 | not evaluated | not evaluated |
| Wallpaper Border #1 | 2.8 | 2.1 | 8.3 |
| Wallpaper Border #2 | <0.5 | <0.5 | not evaluated |

### Example 2

### Effect of Different Textile Components

The following procedure was used to create the adhesive-textile composites of this Example.

The textile component was dipped into bath containing a low surface energy composition comprising, by percent weight of the bath:
4.25% UNIDYNE® TG-992 fluorinated stain release agent
1.00% REPEARL® F-8025 fluorocarbon repellent
1.25% RESIN MRX® block diisocyanate cross-linking agent

The textile was squeezed through pad rolls to achieve a wet pick-up of approximately 50%. The textile was subsequently dried and heat-set on a tenter frame at 390° F. at a rate of 40 yards per minute.

The dried textile was transfer printed on the face side.

The back of the printed textile was coated with ROBOND® PS-8120 HV pressure sensitive adhesive, using one of a number of laboratory wire-wound rod coaters. Each of the coated textile samples was then dried at 250° F. in a lab-scale Despatch oven.

The types of textile components used are listed below.

| | |
|---|---|
| Composite 2A: | double-knit construction containing 2/150/68 |
| | Danbury-textured 100% polyester yarns, 1/150/72 |
| | 100% polyester yarns, and 1/150/36 100% polyester |
| | yarns; 8.7 ounces/yard² |
| Composite 2B: | single needlebar knit construction; 1/150/34 |
| | yarns of 100% polyester; 7.5 ounces/yard² |
| Composite 2C: | twill woven construction; warp of 14/1 open end |
| | spun 65/35 polyester/cotton staple fibers with 3.30 |
| | twist multiple; fill of 12/1 open end spun 65/35 |
| | polyester/cotton staple fibers with 3.25 twist |
| | multiple; 8.5 ounces/yard² |
| Composite 2D: | woven rip-stop construction; 100% nylon |
| | (40 denier yarns) |
| Composite 2E: | hydroentangled spunbonded/spunlace nonwoven |
| | comprised of conjugate polyester/nylon fibers that |
| | have been split into microdeniers having an average |
| | filament size of 0.2 denier/filament; 80 g/m² |

The textile components of Composites 2A and 2B are automotive body cloth, which were treated, before application of the adhesive, with flame retardants and UV stabilizers to enhance the textile component's ability to meet flammability and lightfastness requirements.

Composites 2A-2E were compared to a sample created using a textile described as Composite 4C, which will be discussed presently. Briefly, Composite 4C is a 100% polyester cross-hatch woven textile component that was coated on the back with a wire wound rod coater with a #40 size rod.

Composites 2A-2E were tested using the Rolling Ball Tack and 90-Degree Peel Strength tests outlined previously. The results, as are shown in Data Table 2, were compared with those from Example 4C.

DATA TABLE 2

| Sample | Rolling Ball Tack | 90-Degree Peel |
|---|---|---|
| (description) | (inches) | (lbf/inch) |
| Composite 2A | 12 | 0.38 |
| (knit, polyester) | | |
| Composite 2B | 12 | 0.13 |
| (knit, polyester) | | |
| Composite 2C | 12 | 0.01 |
| (twill woven, poly/cotton) | | |
| Composite 2D | 4.7 | 0.67 |
| (woven, nylon) | | |
| Composite 2E | 3.3 | 1.00 |
| (nonwoven, polyester) | | |
| Composite 4C | 4.5 | 0.60 |
| (woven, polyester) | | |

The surface contour of the textile component appears to have a significant influence on the rolling back tack results. It is believed that this trend is attributable to the coating method used, which tends to push the adhesive into in the “valleys” of the textile component rather than allowing them to remain on the surface yarns. This result allows a ball rolling on the surface to contact less adhesive and, therefore, roll further (as evidenced in the comparison between Composite 2C and 4C, Composite 2C being contoured by its twill weave construction).

Similarly, perhaps, the localized placement of the adhesive may also be responsible for the lower peel strengths of Composites 2A, 2B, and 2C. The contours of the textile component are such that there is less surface contact between the adhesive component and the wall. Accordingly, the adhesive-textile component requires less force to remove.

Modification of the surface contours of the textile component (for example, by surface finishing or through various textile constructions) or increasing the level of add-on may each contribute to an improvement in tack and peel strength.

### Example 3

### Effect of Different Adhesives

Plain weave 100% polyester fabric was treated with release/repel formulation and transfer printed as in Example 2. Three separate adhesives were applied:
Composite 3A: ROBOND® PS-8120 HV methacrylic-based adhesive
Composite 3B: MULTI-LOK® acrylic adhesive
Composite 3C: NACOR® vinyl acetate adhesive

Adhesive compositions were coated on the rear face of the polyester fabric with a # 40 wire wound rod and dried in an oven at 121° C. (250° F.) for 10 minutes. The samples were tested for delamination strength, 90-degree peel strength, and rolling ball tack as described above. In particular, 90-degree peel strength was for the samples applied to unprepared sheetrock.

DATA TABLE 3

| | Adhesive | Rolling Ball | 90-Degree | Delamination |
|---|---|---|---|---|
| | Add-on | Tack | Peel Strength | Strength |
| Sample | (g/m²) | (inches) | (lbf/inch) | (lbf/inch) |
| Composite 3A | 60.0 | 5.5 | 0.15 | 0.87 |
| Composite 3B | 50.1 | 12+ | 0.32 | 3+ |
| Composite 3C | 63.6 | 8.25 | 0.67 | not evaluated |

These results indicate the ability to modify the adhesive properties of the composite by selection of specific adhesives. It is also significant to note that the Composites 3B and 3C damaged the sheetrock when removed from the surface in the 90-degree peel test.

### Example 4

### Evaluation of Different Adhesive Add-on Levels;

### Comparison with Commercially Available Products

A woven fabric having a warp made of 2/150/36 100% polyester yarns with 80 ends/inch and a fill made of 2/150/66 100% polyester yarns with 50 picks/inch was formed in a cross-hatch weave construction. Both of the polyester yarns were used inherently flame retardant. The fabric weight was about 5 ounces/yard.

Four sizes of wire-wound rod coaters were used: a #22 rod, a #30 rod, a #40 rod, and a #60 rod. The samples produced by each of these rods are further identified below as 4A, 4B, 4C, and 4D, respectively.

Data Table 4.1 shows the results of a series of tests conducted on the four samples to measure (a) adhesive add-on amount; (b) rolling ball tack; (c) 90-degree peel strength; and (d) delamination force. The tests were conducted according to the procedures outlined above.

DATA TABLE 4.1

| | | | Rolling | | |
|---|---|---|---|---|---|
| | | Adhesive | Ball | 90-Degree | Delamination |
| | Rod | Add-on | Tack | Peel | Strength |
| Sample | # | (g/m²) | (inches) | (lbf/inch) | (lbf/inch) |
| Composite 4A | 22 | 45 | 11.9 | 0.14 | 0.81 |
| Composite 4B | 30 | 53 | 7.6 | 0.3 | 0.93 |
| Composite 4C | 40 | 59 | 4.5 | 0.6 | 0.96 |
| Composite 4D | 60 | 75 | 3.7 | 0.82 | 1.05 |

Adhesive add-on level is variable, depending on the coating apparatus used to apply the adhesive. Rolling ball tack ranged from 3.7 inches to 11.9 inches. 90-degree peel strength ranged from 0.14 lbf/inch to 0.82 lbf/inch. Delamination strength ranged from 0.81 lbf/inch to 1.05 lbf/inch.

As the adhesive add-on level increases, rolling ball tack decreases and 90-degree peel increases. This indicates that the adhesive properties can be adjusted over a reasonable range by controlling the adhesive add-on, thus facilitating the creation of a repositionable, removable textile composite.

Further, because the delamination strength is greater than the 90-degree peel for each of the four samples, the adhesive-textile composite can be removed from surfaces without significant transfer of the adhesive from the substrate to the surface to which it was adhered.

Rolling ball tack and 90-degree peel strength were also measured for some commercially available adhesive products: duct tape, sold under the Duck® brand by Henkel Consumer Additives; masking tape, sold under the name “Anchor II Advanced Adhesives” by Anchor Continental; and two self-stick wallpaper borders, the first of which was sold under the name “SofTac Adhesive Border” by D.W. Wallcovering and the second of which was sold under the name “Stick'nPlay Self-Stick Activity Border” by Imperial Home Décor Group. Results are shown below in Data Table 4.2.

DATA TABLE 4.2

| | Rolling Ball Tack | 90-Degree Peel |
|---|---|---|
| Adhesive Product | (inches) | (lbf/inch) |
| Duct tape | 3 | 1.16 |
| Masking tape | 12 | 1.07 |
| Wallpaper border #1 | 9 | 0.59 |
| Wallpaper border #2 | 10 | 0.22 |

A comparison of the rolling ball tack and 90-degree peel strength with the examples of Data Table 4.1 indicates that the present adhesive-textile composites can be engineered to have properties similar to those in other commercially available products. However, it should be noted that none of the samples in Data Table 4.2 possesses the combination of properties that are desired for the present adhesive-textile composite (that is, sufficiently high rolling ball tack with sufficiently low 90-degree peel).

The duct tape example—having a rolling ball tack of only 3 inches—indicates an adhesive that is too aggressive to be repositionable. Additionally, the 90-degree peel strength is so high that removal of the duct tape damaged the underlying surface, making substrates with this adhesive incapable of being considered “removable.”

Masking tape has low tack, but also requires more than 1.0 lbf/inch to peel. This type of adhesive also fails to meet the criterion of removability, as removal of the masking tape also damaged the sheetrock.

The two wallpaper borders have relatively low tack and require little force to remove. However, these borders possess low tear strength (as shown in Example 1), making them likely to rip during removal.

### Example 5

### Effect of Different Adhesive Application Methods on Peel Strength

A woven fabric having a warp made of 2/150/36 100% polyester yarns with 80 ends/inch and a fill made of 2/150/66 100% polyester yarns with 50 picks/inch was formed in a cross-hatch weave construction. Both of the polyester yarns were used inherently flame retardant. The fabric weight was about 5 ounces/yard.

This woven textile was dipped into a bath containing a low surface energy composition comprising, by percent weight of the bath:
4.25% UNIDYNE® TG-992 fluorinated stain release agent
1.00% REPEARL® F-8025 fluorocarbon repellent
1.25% RESIN MRX® block diisocyanate cross-linking agent

The textile was squeezed through pad rolls to achieve a wet pick-up of approximately 50%. The textile was subsequently dried and heat-set on a tenter frame at 390 F at a rate of 40 yards per minute.

The dried textile was transfer printed on the face side.

The back of the printed textile was coated with ROBOND® PS-8120 HV pressure sensitive adhesive, using one of a number of coating methods as will be outlined below.

| | |
|---|---|
| Composite 5A: | Gardner knife liquid adhesive set at 20 mil gap |
| Composite 5B: | Gardner knife liquid adhesive set at 25 mil gap |
| Composite 5C: | Gardner knife liquid adhesive set at 30 mil gap |
| Composite 5D: | Gardner knife foamed adhesive set at 40 mil gap |
| Composite 5E: | Gardner knife foamed adhesive set at 50 mil gap |
| Composite 5F: | Gardner knife foamed adhesive set at 60 mil gap |
| Composite 5G: | Wire wound rod coater with rod #22 and liquid adhesive |
| Composite 5H: | Wire wound rod coater with rod #40 and liquid adhesive |
| Composite 5I: | Wire wound rod coater with rod #60 and liquid adhesive |

The foamed adhesive used in Composites 5D, 5E, and 5F were prepared by adding 0.33 grams of ammonium stearate and 0.35 grams of sodium stearate dissolved in 10 grams of water to 100 grams of ROBOND® PS-8120 HV methacrylated-based pressure sensitive adhesive. The mixture was whipped using a Hobart mixer for 3 to 5 minutes, resulting in a cup weight of approximately 34 grams/100 mL.

Measures of adhesive add-on level and results of 90-degree peel strength testing are shown in Data Table 5.

DATA TABLE 5

| | | |
|---|---|---|
| | Adhesive Add-on Level | 90-Degree Peel Strenth |
| Sample | (g/m²) | (lbf/inch) |

Gardner Knife (Liquid Adhesive)

| | | |
|---|---|---|
| Composite 5A | 112 | 0.65 |
| Composite 5B | 171 | 0.63 |
| Composite 5C | 262 | 0.69 |

Gardner Knife (Foamed Adhesive)

| | | |
|---|---|---|
| Composite 5D | 68 | 0.25 |
| Composite 5E | 103 | 0.32 |
| Composite 5F | 110 | 0.50 |

Wire Wound Rod Coater (Liquid)

| | | |
|---|---|---|
| Composite 5G | 45 | 0.14 |
| Composite 5H | 59 | 0.60 |
| Composite 5I | 75 | 0.82 |

All methods used produced acceptable adhesive-textile composites.

Regarding Composites 5A-5C, in which a liquid adhesive was coated onto the textile component using a Gardner knife at increasing gap widths, there appears to be no corresponding increase in peel strength despite the higher levels of adhesive add-on.

For Composites 5D-5F, in which a foamed adhesive was coated onto the textile component using a Gardner knife at increasing gap widths, the peel strength appeared lower vs. add-on level. For example, when comparing Composite 5A (having an adhesive add-on level of 112 g/m²) with Composite 5F (having an add-on level of 110 g/m²), the foamed composite shows less peel strength despite having roughly equivalent levels of adhesive. This may be due to the large foam bubbles generated.

Composites 5G-5I, which were coated using various sizes of wire wound rods, show results similar to those of Composites 5A-5C.

### Example 6

### Effect of Different Processing Conditions on Delamination Strength

A plain weave 100% polyester fabric was treated with release/repel formulation and transfer printed as in Example 2. Six variations of processing conditions were tested using ROBOND® PS-8120 HV acrylic emulsion adhesive. The processing conditions used were as follows:

| | |
|---|---|
| Composite 6A: | Apply adhesive and dry at 121° C. for 10 minutes |
| Composite 6B: | Apply adhesive and dry at room temperature for 48 hours |
| Composite 6C: | Apply adhesive and dry at 149° C. for 10 minutes |
| Composite 6D: | Apply adhesive and dry at room temperature for 48 |
| | hours, then heat to 121° C. for 10 minutes |
| Composite 6E: | Abrasive finishing of rear surface using 600 grit diamond |
| | roll for 24 passes according to process in U.S. Pat. No. |
| | 6,233,795, followed by the application of adhesive and |
| | drying at 121° C. for 10 minutes |
| Composite 6F: | Abrasive finishing of rear surface using 1200 grit |
| | diamond roll for 24 passes according to process in |
| | U.S. Pat. No. 6,233,795, followed by the application of |
| | adhesive and drying at 121° C. for 10 minutes |
| Composite 6G: | Apply adhesive and dry at 121° C. for 10 minutes, |
| | followed by heating in transfer printing press at 400° F. |
| | for 1 minute to reproduce the effects of transfer printing |

Adhesives were applied with a # 40 wire wound rod. The samples were tested for delamination strength as in Example 2, the results of which are recorded in Data Table 6.

DATA TABLE 6

| | Adhesive Add-on | Delamination Strength |
|---|---|---|
| Sample | (g/m²) | (lbf/inch) |
| Composite 6A | 55.6 | 0.95 |
| Composite 6B | 55.0 | 0.72 |
| Composite 6C | 58.6 | 0.93 |
| Composite 6D | 60.5 | 0.96 |
| Composite 6E | 59.4 | 1.14 |
| Composite 6F | 57.3 | 1.08 |
| Composite 6G | 56.5 | 0.99 |

Tests of the default processing conditions described by Composite 6A showed acceptable adhesive performance, with a 90-degree peel strength of 0.60.

However, when air drying was used as in Composite 6B, samples applied to primed wall surfaces exhibited bubbles where the fabric delaminated from the adhesive layer and left residue on the wall after removal. This can be explained in terms of the delamination strength of the adhesive being too close to the peel strength for air-dried composites.

Various other processing conditions (Composites 6C through 6G) have been demonstrated to further increase the gap between delamination and 90-degree peel strength, thereby reducing the chance of undesirable delamination of adhesive during use.

When engineering an adhesive to have appropriate level of peel strength, it is important the nature (i.e., smoothness) of the surface to which the adhesive-textile composite will be applied. It is well known that the nature of the surface strongly affects the peel strength of, the adhesive bond. For example, rough, fibrous, or hydrophobic surfaces decrease peel strength, while smooth, hydrophilic surface tend to increase peel strength. In all cases, it is desirable to have the delamination strength of the composite be higher than the peel strength.

The results of this Example show various processing methods that may be used to ensure that the delamination strength remains sufficiently higher than the anticipated peel strength, given the characteristics of a surface to which the composite will be removably adhered.

### Example 7

### Effect of Different Adhesive Additives

A plain weave 100% polyester fabric was treated with release/repel formulation and transfer printed as in Example 2. Eight adhesive compositions were made by combining single adhesive additives with ROBOND® PS-8120 HV acrylic emulsion adhesive. The additives used were:

| | |
|---|---|
| Composite 7A: | Control; no additive |
| Composite 7B: | 1 wt % UNIDYNE ® TG-992 fluorochemical |
| Composite 7C: | 5 wt % ROVACE ® 117 hardener/detackifier |
| Composite 7D: | 10 wt % ROVACE ® 117 hardener/detackifier |
| Composite 7E: | 1 wt % RESIN MRX ® block diisocyanate |
| | cross-linking agent |
| Composite 7F: | 1 wt % SURFONYL ® PSA-336 wetting agent |
| Composite 7G: | 0.5 wt % ACRYSOL ® ASE-60 thickener |
| Composite 7H: | 1 wt % ACRYSOL ® ASE-60 thickener |

Adhesive compositions were coated on the rear face of the polyester fabric with a #40 wire wound rod and dried in an oven at 121° C. (250° F.) for 10 minutes. The samples were tested for delamination strength, 90-degree peel strength, and rolling ball tack as in Example 2. In particular, 90-degree peel strength was for the samples applied to unprepared wallboard.

DATA TABLE 7

| | Adhesive | Rolling Ball | 90-Degree | Delamination |
|---|---|---|---|---|
| | Add-on | Tack | Peel Strength | Strength |
| Sample | (g/m²) | (inches) | (lbf/inch) | (lbf/inch) |
| Composite 7A | 60.0 | 5.5 | 0.15 | 0.87 |
| Composite 7B | 55.3 | 12+ | not evaluated | 0.99 |
| Composite 7C | 58.0 | 9.75 | not evaluated | 1.09 |
| Composite 7D | 58.0 | 11 | not evaluated | 1.32 |
| Composite 7E | 55.2 | 7.25 | 0.01 | 1.31 |
| Composite 7F | 60.8 | 9.5 | 0.10 | 1.30 |
| Composite 7G | 57.7 | 7.25 | 0.26 | not evaluated |
| Composite 7H | 64.1 | 8.24 | 0.18 | 1.47 |

These tests illustrate the ability to modify adhesive properties through judicious use of additives. In particular, certain compositions (7F and 7H) were shown to improve the delamination strength of the adhesive-without negatively affecting the 90-degree peel strength.

### Example 8

### Effect of Adhesive Penetration Depth

An adhesive composition containing 1% ACRYSOL® ASE-60 thickening agent in ROBOND® PS-8120 HV acrylic pressure sensitive adhesive was applied to two plain weave 100% polyester textiles that had different types of hydrophobic surfaces. The textile component of Composite 8A was prepared as in Example 2. The textile component of Composite 8B was the same greige fabric as in Example 2, but it was not treated with release chemistry.

The adhesive composition was coated on the rear face of the textile components with a #40 wire wound rod, after which the adhesive-applied textile was dried in an oven at 121° C. (250° F.) for 10 minutes to create an adhesive-textile composite. Composites 8A and 8B were tested for delamination strength, using the technique previously described.

DATA TABLE 8

| | Adhesive Add-on | Delamination Strength |
|---|---|---|
| Sample | (g/m2) | (lbf/inch) |
| Composite 8A | 64.1 | 1.47 |
| (with release chemistry) | | |
| Composite 8B | 37.2 | 2.36 |
| (without release chemistry) | | |

In Composite 8A, the majority of the adhesive remained as a discrete surface layer on the textile component while in Composite 8B, the majority of the adhesive penetrated into the textile component. The greater penetration of the adhesive into the fabric resulted in much higher delamination strength and illustrates the ability to improve delamination strength by increasing penetration of adhesive into the textile component. An additional observed benefit of increased adhesive penetration is a decrease in the tendency to unravel at cut edges.

### Example 9

### Effect of Accelerated Aging

### Present Composites vs. Commercially Available Products

The next set of tests was designed to determine the ability of the present adhesive-textile composite to withstand aging. For comparison, the textile component and wallpaper borders used in Example 4 were also subjected to the same test conditions and evaluated.

The back of the textile components was coated with ROBOND® PS-8120 HV pressure sensitive adhesive, using one of a number of laboratory wire-wound rod coaters. Three sizes of wire-wound rod coaters were used: a #30 rod, a #40 rod, and a #50 rod. The samples produced by each of these rods are further identified below as 9A, 9B, and 9C, respectively. Each of the coated textile samples was then dried at 250° F. in a lab-scale Despatch oven.

The adhesive-textile composites and the two wallpaper borders were applied to primed sheetrock using a five-pound roller. The samples were tested for 90-degree peel strength 24 hours after application. Multiple samples were aged simultaneously, using the process of ASTM Test Method D-3611-89, Where five samples of each were tested after 240 hours and the remaining five samples of each were tested after 480 hours. After 240 hours and 480 hours of accelerated aging, the samples were equilibrated to room temperature and the 90-degree peel strength test was conducted. The averaged results are shown in Data Table 9.

| | DATA TABLE 9 | | |
|---|---|---|---|
| | 90-Degree Peel Strength (lbf/inch) | | |
| Sample | Initial | After 240 Hours | After 480 Hours |
| Wallpaper border #1 | 0.59 | 1.12 | 1.02 |
| Wallpaper border #2 | 0.22 | 0.88 | 0.75 |
| Composite 9A | 0.30 | 0.43 | 0.33 |
| Composite 9B | 0.60 | 1.12 | 0.70 |
| Composite 9C | 0.50 | 0.51 | 0.74 |

All of the samples remained affixed to the sheetrock after exposure to the test conditions, indicating that the samples will remain attached for 5 to 10 years of use (represented by 240 hours and 480 hours of accelerated aging, respectively). All of the samples tested required more force to remove after 480 hours of accelerated aging than each did initially. However, the composites of the present disclosure experienced more long-term adhesive stability than did the wallpaper borders.

In removing the wallpaper borders after both 240 hours and 480 hours of accelerated aging, the sheetrock was damaged. Additionally, these paper-based borders were easily torn during removal.

In contrast, the three composite samples were removed with little to no damage to the sheetrock or to the composites themselves.

In a separate trial conducted using ASTM Test Method D-3611-89, a strip of Composite 9B having an approximate size of 1 inch by 40 inches was wrapped tightly around a wooden, ¼ inch diameter dowel and aged. After both 240 hours and 480 hours, the composite easily unwound without becoming adhered to itself. The unwound composite also retained its adhesive characteristics.

### Example 10

### Effect of Low Surface Energy Treatment on Roll-Up

To test the effect of a low surface energy treatment on the ability to roll-up the adhesive-textile composite, the following experiment was conducted.

An adhesive-textile composite was prepared, according to Example 6A, using ROBOND® PS-8120 HV acrylic emulsion adhesive on a 100% polyester woven fabric.

A 2×6 in strip of the adhesive-textile composite was adhered to two textile surfaces, one of which (Surface 10A) was treated with the release chemistry of Example 2 and one of which (Surface 10B) was untreated. The textile surfaces were otherwise identical. The 90-degree peel strength was measured, according to the previous description, to determine the amount of force required to remove the composite from a textile surface (designed to mimic the adhesive-textile composite in its rolled-up form).

The results are shown in Data Table 10.

DATA TABLE 10

| | 90-Degree |
|---|---|
| | Peel Strength |
| Example | (lbf/inch) |
| Surface 10A (treated with release chemistry) | 0.0023 |
| Surface 10B (not treated with release chemistry) | 0.0155 |

For both surface, the peel strength was much lower than the observed 90-degree peel strength from a non-textile surface (e.g., primed sheetrock). That is, the force required for self-release in these cases, where hydrophobic surfaces are present, is much lower than force required to remove the adhesive-textile composite from a non-textile surface. This translates to a product that is easy to unroll during application.

### Example 11

### Use of Tufted Textile in Composite

A tufted textile component (i.e., a carpet substrate), comprised of a plurality of olefin yarns tufted through a nonwoven substrate, was used to create an adhesive textile composite. On the rear surface of the nonwoven substrate was a polyurethane film, to which ROBOND® PS-8120 HV acrylic pressure sensitive adhesive was applied. The weight of the tufted textile component was about 0.83 g/in². The tufted textile-adhesive composite was adhered to a vertical wall surface and showed no problems with delamination or with inability to remain adhered.

### Example 12

### Use of Thermoplastic Hot-Melt Polymer

A woven fabric was prepared according to the Example of U.S. Pat. No. 6,541,402, to Kimbrell, Jr. et al., the details of which are as follows. A woven fabric having a 150 denier warp with 133 ends and a 690 denier (textured) fill with 45 ends was formed from solution dyed nylon yarn (available from Cookson Fibers under the tradename Camac™) on a Jacquard loom to yield a 100% Jacquard weave nylon woven fabric.

The loom state fabric was thereafter scoured and thereafter padded on both sides with a solution containing about 1%-40% (about 6.6% preferred) of a fluorochemical such as REPEARL® F-8025; about 0.5%-5.0% (about 3.0% preferred) ULTRA-FRESH NM™; and about 0.05%-1.0% (about 1.0% preferred) ULTRA-FRESH 40™ (antimicrobial agents, both available from Thompson Research) with the remainder of the solution being made up of water.

While in the preferred practice, this solution will include an antimicrobial component, it is to be understood and appreciated that one or more of these additional components may be eliminated if desired. Following the padding application of this preparation solution, the fabric is cured at a temperature of about 225° F. to 425° F. preferably about 350° F. for 60 seconds. The woven fabric substrate with applied fluorochemical stain resist agent is thereafter heated to a temperature of about 90° F. to 410° F. (225° F. preferred) and passed to an extrusion coater.

As will be appreciated by those of skill in the art, extrusion coating involves the process of extruding a molten film from a die and contacting this molten film with the fabric substrate under pressure in the nip of two counter-rotating rolls. In the preferred practice, one of these rolls is a chill roll, which is in contact with the surface being coated while the other roll is a deformable rubber material, which is in contact with the side remaining uncoated. Through use of such a configuration and in the preferred embodiment, a layer of molten ethylene methyl acrylate (EMA) having 20% MA substitution on the ethylene backbone, is spread across and forced into the fabric which has undergone fluorochemical treatment. This molten EMA is preferably applied at a temperature of about 580° F. while the chill roll is preferably held at a temperature of about 55° F. One potentially preferred (EMA) composition is EMA 806-009, available from Equistar Chemicals of Cincinnati, Ohio, which includes an elastomeric component therein. Necessarily injected within the manufacturing operation is a wax or wax-like chemical, which acts as a release agent for the EMA when in con tact with the chill roll. Such a chemical, such as Acrawax™ from Lonza Chemical, thus allows for a continuous, clean application of the preferred EMA, which, without a release agent, would remain contacted with the chill roll and “gum up” the extrusion apparatus. The line speed of the fabric itself is preferably about 100 feet per minute through the machine. This operation leads to a configuration wherein the EMA coating substantially covers and surrounds the yarn of the fabric over a-large surface area so as to promote good mechanical adhesion. In addition, the coating material is pressed into the interstices, which may still exist between the individual yarns so as to provide a barrier to fluid passage therebetween. In the preferred practice, the total thickness of the applied barrier layer is between about 1.00 and 5.00 mils, preferably between about 1.50 and 2.50 mils, and most preferably between about 1.75 and 2.25 mils.

The resulting product has a high degree of stain repellency and possesses antifungal and anti-bacterial properties. The polymeric back-coating, consisting of thermoplastic hot-melt polymer, is not tacky at room temperature.

A sample of this composite was ironed onto primed sheetrock with a Sunbeam iron set to the setting recommended for nylon textiles.

The 90-degree peel strength, when removed after heating, was 0.70 lbf/inch, indicating sufficient adhesion to remain fixed to a surface.

1. An adhesive textile composite, said adhesive-textile composite comprising:
a mechanically fabricated textile component having a face side and a back side, said textile component being comprised of organic fibers and having a tear strength of at least 10 lbs. in the machine direction and the cross-machine direction, when measured according to ASTM D-5733-99, and wherein at least the face side of said textile component comprises a hydrophobic surface; and
a pressure sensitive adhesive applied to the back side of said textile component.

2. The adhesive-textile composite of claim 1, wherein said hydrophobic surface of said textile component comprises a treatment selected from the group consisting of fluorochemicals, silicones, and waxes.

3. The adhesive-textile composite of claim 1, wherein said textile component has a construction selected from the group consisting of woven, knit, nonwoven, tufted, and bonded.

4. The adhesive-textile composite of claim 1, wherein said textile component comprises fibers selected from the group consisting of cotton, rayon, polypropylene, polyester, nylon, acrylic, olefins, and blends thereof.

5. The adhesive-textile composite of claim 4, wherein said textile component comprises polyester.

6. The adhesive-textile composite of claim 1, wherein said pressure sensitive adhesive is an acrylate-based adhesive.

7. The adhesive-textile composite of claim 5, wherein said adhesive-textile composite exhibits a rolling ball tack of between 3 inches and 12 inches.

8. The adhesive-textile composite of claim 5, wherein said adhesive-textile composite exhibits a 90-degree peel strength of between 0.10 lbf/inch and 1.00 lbf/inch.

9. The adhesive-textile composite of claim 1, wherein said adhesive-textile composite exhibits a 90-degree peel strength that is at least 0.20 lbf/inch lower than its delamination strength.

10. The adhesive-textile composite of claim 1, wherein, after said adhesive-textile composite has been applied to a surface and removed from said surface, said surface retains substantially the same appearance as before said adhesive-textile composite was applied.

11. The adhesive-textile composite of claim 1, wherein a thickening agent is incorporated into said pressure sensitive adhesive.

12. The adhesive-textile composite of claim 1, wherein said textile component further comprises at least one stain release composition.

13. The adhesive-textile composite of claim 1, wherein said adhesive-textile composite further comprises at least one antimicrobial compound.

14. The adhesive-textile composite of claim 1, wherein said adhesive-textile composite further comprises at least one flame retardant compound.

15. An adhesive-textile composite, said adhesive-textile composite comprising:
a mechanically fabricated textile component having a face side and a back side, said textile component being comprised of organic fibers and having a tear strength of at least 10 lbs. in the machine direction and the cross-machine direction, when measured according to ASTM D-5733-99; and
a thermoplastic hot-melt polymer applied to the back of said textile component.

16. The adhesive-textile composite of claim 15, wherein said hydrophobic surface of said textile component comprises a treatment selected from the group consisting of fluorochemicals, silicones, and waxes.

17. The adhesive-textile composite of claim 15, wherein said textile component has a construction selected from the group consisting of woven, knit, nonwoven, tufted, and bonded.

18. The adhesive-textile composite of claim 15, wherein said textile component comprises fibers selected from the group consisting of cotton, rayon, polypropylene, polyester, nylon, acrylic, olefins, and blends thereof.

19. The adhesive-textile composite of claim 18, wherein said textile component comprises polyester.

20. The adhesive-textile composite of claim 15, wherein said thermoplastic hot-melt polymer is acrylate-based.

21. The adhesive-textile composite of claim 15, wherein, after said adhesive-textile composite has been applied to a surface and removed from said surface, said surface retains substantially the same appearance as before said adhesive-textile composite was applied.

22. The adhesive-textile composite of claim 15, wherein said textile component further comprises at least one stain release composition.

23. The adhesive-textile composite of claim 15, wherein said adhesive-textile composite further comprises at least one antimicrobial compound.

24. The adhesive-textile composite of claim 15, wherein said adhesive-textile composite further comprises at least one flame retardant compound.
